(19) United States
(12) Patent Application Publication
(10) Pub. No.: US 2010/0003212 A1
(43) Pub. Date: Jan. 7, 2010

(54) POLYMERS WITH ANTIMICROBIAL ACTIVITY CONTAINING QUATERNARY AMMONIUM GROUPS

(76) Inventors: Georg L. Kis, Triboltingen (CH); Benoit Pugin, Muenchenstein (CH); Barbel Fobel, Basel (CH)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 12/305,227

(22) PCT Filed: Jun. 25, 2007
(86) PCT No.: PCT/EP2007/005619

§ 371 Date: Dec. 17, 2008

(30) Foreign Application Priority Data
Jun. 26, 2006 (EP) 06013109.1

(51) Int. Cl. A01N 33/12; C08F 8/30; A01P 1/00

(52) U.S. Cl. 424/78.27; 525/378

(57) ABSTRACT

The present invention relates to novel articles and the like, typically exhibiting antimicrobial efficacy which articles contain for example a carrier, a spacer attached to the carrier and one or more quaternary ammonium groups attached directly or indirectly to said spacer.

The present invention relates to novel articles, typically exhibiting antimicrobial efficacy which articles contain for example a carrier, a spacer attached to the carrier and one or more quaternary ammonium groups attached directly or indirectly to said spacer.

Pharmaceutical compositions have to meet certain criteria with respect to sterility and/or with respect to the contamination with bioburden which typically occurs during multiple administration, especially by so-called multi-dose presentations. This problem has been solved in the art by adding preservatives to such a pharmaceutical composition. However, preserved pharmaceutical compositions very often give raise to poor tolerability due to the preservative. This problem could for example be solved by removing such a preservative before administration by adequate measures.

However, it has now been surprisingly found that articles exhibiting antimicrobial efficacy and being insoluble in such pharmaceutical compositions may solve said above described problems in a highly efficient and simple way, e.g. by contacting a pharmaceutical composition with such an article, and said article may represent partially or entirely the material used for a primary packaging. For example, a primary packaging device consisting of an article in accordance to this invention imparts protection to a pharmaceutical composition contained therein against contamination with micro-organisms, e.g. bacteria, fungi and the like. Upon dispensation, a pharmaceutical composition has typically not more than the acceptable amount of micro-organisms and is typically virtually free of any preservatives.

Accordingly, in a first aspect the invention pertains to an article comprising a carrier, a spacer and one of more different quaternary ammonium groups being attached directly or indirectly to said spacer.

An article of this invention is typically insoluble in a pharmaceutical composition, in particular in aqueous pharmaceutical compositions. Therefore, pharmaceutical compositions may be easily separated from an article and vice-versa via simple physical operations such as filtration and the like.

It is an important aspect of this invention that an article comprises as many quaternary ammonium groups as possible, and said quaternary ammonium groups are preferably on the surface of said article.

In another aspect the present invention pertains to an article comprising a carrier, at least a linking group, optionally a linking element, one or more different spacers and one or more identical or different quaternary ammonium groups attached directly or indirectly e.g. via a linking element to said ionic polymer wherein the quaternary ammonium group content is from 0.01-10% by weight of nitrogen based on the total amount of said spacer.

Typically, the content of the quaternary ammonium groups being incorporated into an article of the invention is from 0.01-10% nitrogen, preferably from 0.05-5%, preferably from 0.1-3% of the total weight of the macromer being attached, e.g. via grafting to a carrier

In another aspect the invention pertains to an article comprising a carrier, optionally a linking element, a linking group, a spacer and a quaternary ammonium group,

wherein the carrier defines the initial portion and the quaternary ammonium group defines a terminal portion of said article,
wherein the spacer, the linking group, and the optional linking element define an intermediate zone between said carrier and said ammonium group, and wherein said carrier, spacer and said optional linking element are connected to each other by a linking group, and
wherein said quaternary ammonium group is attached to said intermediate zone via a carbon atom of the linking element, or alternatively via a carbon atom of the spacer.

In the embodiment of the foregoing paragraph, the amount quaternary ammonium group is from 0.01-25% by weight of nitrogen, preferably from 0.05-12%, also preferably from 0.1-6% of the total weight of said intermediate zone.

In a further aspect of the foregoing a linking element is selected from -A-, the linking group is selected from X₁, X₂, and X₃, the spacer is selected from an ionic polymer, a non-ionic polymer, and from a mixture thereof, and the total amount of quaternary ammonium groups is from 0.01-25% by weight of nitrogen, preferably from 0.05-12%, also preferably from 0.1-6% of the total weight of said intermediate zone.

In another aspect the invention an article comprises a carrier and a macromer attached thereto,

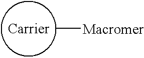

wherein said macromer is of formula (I),

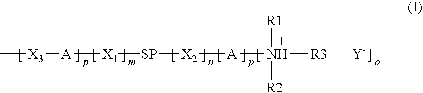

wherein -A- is independent from each other and represents a linking element which linking element has m+1 or o+1 valences, X₁, X₂, and X₃ are the same or different and are a linking group, SP is a spacer having n+1 valences, and —N(R₁R₂R₃)⁺ represents a positively charged quaternary ammonium group;
m, n and o are independent from each other and represent an integer from 1-10, preferably 1-7, and more preferably from 1-4, p is independent from each other and is 0 or 1, Y⁻ represents a negatively charged inorganic or organic moiety, and the quaternary ammonium group content is from 0.1-10% by weight of nitrogen based on the total amount of said macromer.

As used herein, the term valence defines the number of ligands, building blocks, radicals, groups or atoms being attached to a linking element or a spacer. For example, a valence of 2 denotes a spacer with 2 ligands attached thereto. An analogues term for a spacer with 2 ligands is the term a bivalent spacer.

Accordingly, the present invention also pertains to a novel macromer of formula (I) as defined above, and its antimicrobial use in particular but not only in an article as described above.

The inventive macromers might be used in a grafting process, e.g. grafting to the functionalized surface of a carrier, or said macromers might be copolymerized with an unsaturated comonomer to furnish novel copolymers having a high content of quaternary ammonium groups.

A comonomer present in the novel polymer can be hydrophilic or hydrophobic or a mixture thereof. Suitable comonomers are, in particular, those which are usually used in the production of contact lenses and biomedical materials.

A hydrophobic comonomer is taken to mean a monomer which typically gives a homopolymer which is insoluble in water and can absorb less than 10% by weight of water.

Analogously, a hydrophilic comonomer is taken to mean a monomer which typically gives a homopolymer which is soluble in water or can absorb at least 10% by weight of water.

Suitable hydrophobic comonomers are, without this being an exhaustive list, C1-C18alkyl and C3-C18cycloalkyl acrylates and methacrylates, C3-C18alkylacrylamides and -methacrylamides, acrylonitrile, methacrylonitrile, vinyl C1-C18alkanoates, C2-C18alkenes, C2-C18haloalkenes, styrene, (lower alkyl)styrene, lower alkyl vinyl ethers, C2-C10perfluoroalkyl acrylates and methacrylates and correspondingly partially fluorinated acrylates and methacrylates, C3-C12 perfluoroalkylethylthiocarbonylaminoethyl acrylates and methacrylates, acryloxy- and methacryloxyalkylsiloxanes, N-vinylcarbazole, C1-C12alkyl esters of maleic acid, fumaric acid, itaconic acid, mesaconic acid and the like. Preference is given, for example, to acrylonitrile, C1-C4alkyl esters of vinylically unsaturated carboxylic acids having 3 to 5 carbon atoms or vinyl esters of carboxylic acids having up to 5carbon atoms.

Examples of suitable hydrophobic comonomers are methyl acrylate, ethyl acrylate, propyl acrylate, isopropyl acrylate, cyclohexyl acrylate, 2-ethylhexyl acrylate, methyl methacrylate, ethyl methacrylate, propyl methacrylate, butyl acrylate, vinyl acetate, vinyl propionate, vinyl butyrate, vinyl valerate, styrene, chloroprene, vinyl chloride, vinylidene chloride, acrylonitrile, 1-butene, butadiene, methacrylonitrile, vinyltoluene, vinyl ethyl ether, perfluorohexylethylthiocarbonylaminoethyl methacrylate, isobornyl methacrylate, trifluoroethyl methacrylate, hexafluoroisopropyl methacrylate, hexafluorobutyl methacrylate, tristrimethylsilyloxysilylpropyl methacrylate (TRIS), 3-methacryloxypropylpentamethyldisiloxane and bis(methacryloxypropyl)tetramethyldisiloxane.

Preferred examples of hydrophobic comonomers are methyl methacrylate, TRIS and acrylonitrile.

Suitable hydrophilic comonomers are, without this being an exhaustive list, hydroxyl-substituted lower alkyl acrylates and methacrylates, acrylamide, methacrylamide, (lower alkyl)acrylamides and -methacrylamides, ethoxylated acrylates and methacrylates, hydroxyl-substituted (lower alkyl)acrylamides and -methacrylamides, hydroxyl-substituted lower alkyl vinyl ethers, sodium vinylsulfonate, sodium styrenesulfonate, 2-acrylamido-2-methylpropanesulfonic acid, N-vinylpyrrole, N-vinyl-2-pyrrolidone, 2-vinyloxazoline, 2-vinyl-4,4′-dialkyloxazolin-5-one, 2- and 4-vinylpyridine, vinylically unsaturated carboxylic acids having a total of 3 to 5carbon atoms, amino(lower alkyl)- (where the term “amino” also includes quaternary ammonium), mono(lower alkylamino)(lower alkyl) and di(lower alkylamino)(lower alkyl)acrylates and methacrylates, allyl alcohol and the like. Preference is given, for example, to N-vinyl-2-pyrrolidone, acrylamide, methacrylamide, hydroxyl-substituted lower alkyl acrylates and methacrylates, hydroxy-substituted (lower alkyl)acrylamides and -methacrylamides and vinylically unsaturated carboxylic acids having a total of 3 to 5carbon atoms.

Examples of suitable hydrophilic comonomers are hydroxyethyl methacrylate (HEMA), hydroxyethyl acrylate, hydroxypropyl acrylate, trimethylammonium 2-hydroxy propylmethacrylate hydrochloride (Blemer/QA, for example from Nippon Oil), dimethylaminoethyl methacrylate (DMAEMA), dimethylaminoethylmethacrylamide, acrylamide, methacrylamide, N,N-dimethylacrylamide (DMA), allyl alcohol, vinylpyridine, glycerol methacrylate, N-(1,1-dimethyl-3-oxobutyl)acrylamide, N-vinyl-2-pyrrolidone (NVP), acrylic acid, methacrylic acid and the like.

Preferred hydrophilic comonomers are 2-hydroxyethyl methacrylate, dimethylaminoethyl methacrylate, trimethylammonium 2-hydroxypropylmethacrylate hydrochloride, N,N-dimethylacrylamide and N-vinyl-2-pyrrolidone.

The novel copolymers are synthesized in a manner known per se from the corresponding monomers (the term monomer here also including a comonomer and a macromer according to the definition of the formula (I)) by a polymerization reaction customary to the person skilled in the art. Usually, a mixture of the abovementioned monomers is warmed with addition of a free-radical former. Examples of such free-radical formers are azodiisobutyronitrile (AIBN), potassium peroxodisulfate, dibenzoyl peroxide, hydrogen peroxide and sodium percarbonate. If, for example, said compounds are warmed, free radicals form with homolysis, and can then initiate, for example, a polymerization.

A polymerization reaction can particularly preferably be carried out using a photoinitiator. In this case, the term photopolymerization is used. In the photopolymerization, it is appropriate to add a photoinitiator which can initiate free-radical polymerization and/or crosslinking by using light. Examples thereof are customary to the person skilled in the art; suitable photoinitiators are, in particular, benzoin methyl ether, 1-hydroxycyclohexylphenyl ketone, Darocur and Irgacur products, preferably Darocur1173/ and Irgacur2959/. Also suitable are reactive photoinitiators, which can be incorporated, for example, into a macromer, or can be used as a specific comonomer. Examples thereof are given in EP0632329. The photopolymerization can then be initiated by actinic radiation, for example light, in particular UV light having a suitable wavelength. The spectral requirements can, if necessary, be controlled appropriately by addition of suitable photosensitizers.

A polymerization can be carried out in the presence or absence of a solvent. Suitable solvents are in principle all solvents which dissolve the monomers used, for example water, alcohols, such as lower alkanols, for example ethanol or methanol, furthermore carboxamides, such as dimethylformamide, dipolar aprotic solvents, such as dimethyl sulfoxide or methyl ethyl ketone, ketones, for example acetone or cyclohexanone, hydrocarbons, for example toluene, ethers, for example THF, dimethoxyethane or dioxane, halogenated hydrocarbons, for example trichloroethane, and also mixtures of suitable solvents, for example mixtures of water and an alcohol, for example a water/ethanol or water/methanol mixture.

A polymer network can, if desired, be reinforced by addition of a crosslinking agent, for example a polyunsaturated comonomer. In this case, the term crosslinked polymers is preferably used.

The invention therefore furthermore relates to a crosslinked polymer comprising the product of the polymerization of a macromer of the formula (I), if desired with at least one vinylic comonomer and with at least one polyunsaturated comonomer.

Examples of typical polyunsaturated comonomers are allyl (meth)acrylate, lower alkylene glycol di(meth)acrylate, poly(lower alkylene) glycol di(meth)acrylate, lower alkylene di(meth)acrylate, divinyl ether, divinyl sulfone, di- and trivinylbenzene, trimethylolpropane tri(meth)acrylate, pentaerythritol tetra(meth)acrylate, bisphenol A di(meth)acrylate, methylenebis(meth)acrylamide, triallyl phthalate and diallyl phthalate.

The amount of the polyunsaturated comonomer used is expressed in a proportion by weight based on the total polymer and is typically in the range from 20 to 0.05%, in particular in the range from 10 to 0.1%, preferably in the range from 2 to 0.1%.

Hence, another embodiment relates also to a copolymer which comprises the polymerization product of the following components in weight percent based on the total weight of the polymer:

(1) 45-65% of a macromer according to formula (I),
(2) 15-30% of a hydrophobic monomer, and
(3) 10-35% of a hydrophilic monomer, and
(4) optionally 0.1-10% of a polyunsaturated comonomer.

### The Carrier:

As used herein, a carrier means typically a polymeric material such as a homo-polymer, co-polymer, natural and synthetic rubber and their blends and alloys with other materials such as inorganic fillers, and matrix composites. Such polymeric material may be used as materials on their own or alternatively as an integral and uppermost part of a multi-layer laminated sandwich comprising any materials such as polymers, metals, ceramics or an organic coating on any type of substrate material.

Examples of the polymeric material suitable for surface modification include: polyolefins such as low density polyethylene (LDPE), polypropylene (PP), high density polyethylene (HDPE), ultra high molecular weight polyethylene (UHMWPE); blends of polyolefins with other polymers or rubbers or with inorganic fillers; grafted polyolefins such as a PP or PE which upon funtionalization is grafted with a hydrophilic comonomer such as vinylalcohol and a co-reactant such as a diisocyanate, polyethers. such as polyoxymethylene (Acetal); polyamides, such as poly(hexamethylene adipamide) (Nylon 66); halogenated polymers, such as polyvinylidenefluoride (PVDF), polytetra-fluoroethylene (PTFE), fluorinated ethylene-propylene copolymer (FEP), and polyvinyl chloride (PVC); aromatic polymers, such as polystyrene (PS); ketone polymers such as polyetheretherketone (PEEK); methacrylate polymers, such as polymethylmethacrylate (PMMA); polyesters, such as polyethylene terephthalate (PET); polyurethanes; epoxy resins; and copolymers such as ABS and ethylenepropylenediene (EPDM). Natural or synthetic rubber referred to in this patent includes pure rubber, mixture of rubber blends or alloys of rubber with polymer. The rubber can be in virgin or vulcanised or crosslinked form while vulcanised rubber is preferable. Suitable rubbers and rubber based materials for use in the invention include, but are not limited to, natural rubber, ethylene-propylene diene rubber, synthetic cis-polyisoprene, butyl rubber, nitrile rubber, copolymers of 1,3-butadiene with other monomers, for example styrene, acrylonitrile, isobutylene or methyl methacrylate, and ethylene-propylene-diene terpolymer. The term “vulcanised rubber” as used herein includes vulcanised rubbers and vulcanised rubbers mixed with fillers, additives, and the like. Examples, of filler and additives include carbon black, silica, fiber, oils, and zinc oxide.

Preferred carriers are polyolefins, grafted polyolefins, polyethers, polyamides, polystyrenes, methacrylate polymers and mixtures thereof. In particular preferred are polyethylene, polypropylene, grafted polyethylene, grafted polypropylene, and mixtures thereof.

### The Linking Group X₁, X₂, X₃

X₁, X₂ and X₃ are the same or different and represent a bivalent group selected from: —O—, —S—, —CO—, —COO—, —OCO—, —NHCO—, —CONH—, —NHCOO—, —OCONH—, or a bond. Preferably X₁ is —O—, —S—, —CO—, —NHCO—, —CONH—, —NHCOO—, or —OCONH—, more preferably —O—, —S—, —NHCO—, —NHCOO—, or —OCONH—.

The linking element -A-:

A linking element is either present or absent, and stands for alkylene, alkylene-arylene, arylene-alkylene, arylene, or alkylene-arylene-alkylene, and has up to 50 carbon atoms. Alkylene A can be cyclic, linear or branched or a combination thereof.

The linking element A is at least bivalent, but is typically multivalent, e.g. A may have 3, 4, 5, 6, 7, 8, 9, 10, 11, 12, or up to 50 valences, or in case of macromer (I) the valence of A is from 2-10.

Arylene is preferably phenylene or naphthylene, which is unsubstituted or substituted by lower alkyl or lower alkoxy, in particular 1,3-phenylene, 1,3,4-trisubstituted phenyl or methyl-1,4-phenylene; or 1,2,5-trisubstituted naphthyl or 1,2,7,8-tetrasubstituted naphthyl.

Alkylenearylene and arylenealkylene have up to 50 carbon atoms and are at least bivalent, the valence of alkylenearylene and arylenealkylene is from 2-10. Examples are benzylene or benzylene optionally substituted by from 1 to 3 methylene groups.

Such a linking element might be typically obtained by reacting a molecule carrying 2, 3, or 4 isocyanate groups with a polymer, e.g. polyvinylalcohol, and/or with a functionalized carrier carrying hydroxy groups. Such a reaction would furnish urethane linking elements, i.e. —NHCOO—, or —OCONH— attached to said carrier or to said isocyanate molecule. Therefore in a preferred aspect, a linking element is derived from a diisocyanate which may be selected from the group of isophorone diisocyanate (IPDI), toluylene-2,4-diisocyanate (TDI), 4,4′-methylenebis(cyclohexyl isocyanate), 1,6-diisocyanato-2,2,4-trimethyl-n-hexane (TMDI), methylenebis(phenyl isocyanate), methylenebis(cyclohexyl-4-isocyanate) and hexamethylene diisocyanate (HMDI). A linking element may also be selected from a triisocyanate such as examples of triisocyanates are compounds of formula (T1), (T2) or (T3)

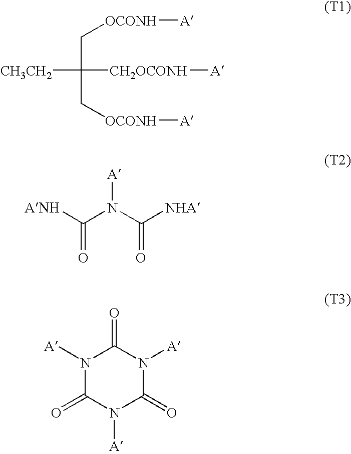

wherein each A′, independently of the others, is —(CH₂)₆—NCO or

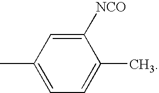

Those compounds are, especially, known triisocyanates commercially available under the names Desmodur®L, Desmodur®N or Desmodur®N-3000, and Mondur®CB examples of triisocyanates are compounds of formula (T1), (T2) or (T3)

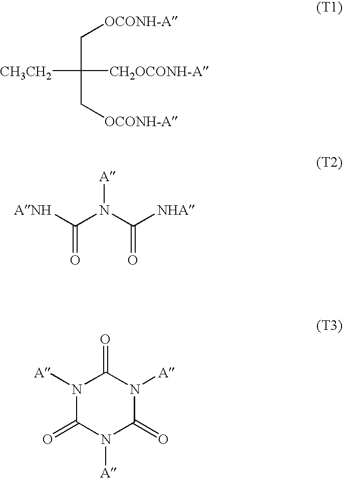

wherein each D, independently of the others, is —(CH₂)₆—NCO or

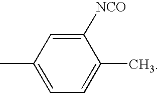

Those compounds are, especially, known triisocyanates commercially available under the names Desmodur®L, Desmodur®N or Desmodur®N-3000, and Mondur®CB.

### The Spacer:

As used herein a spacer may be selected from an ionic polymer, non-ionic polymer or from a mixture thereof.

The ionic polymer may be cationic or anionic. A suitable anionic polymer is, for example, a synthetic polymer, biopolymer or modified biopolymer comprising carboxy, sulfo, sulfato, phosphono or phosphato groups or a mixture thereof, or a salt thereof, for example a biomedical acceptable salt and especially an ophthalmically acceptable salt thereof.

Examples of synthetic anionic polymers are: a linear polyacrylic acid (PAA), a branched polyacrylic acid, for example a Carbophil® or Carbopol® type from Goodrich Corp., a poly-methacrylic acid (PMA), a polyacrylic acid or polymethacrylic acid copolymer, for example a copolymer of acrylic or methacrylic acid and a further vinylmonomer, for example acrylamide, N,N-dimethyl acrylamide or N-vinylpyrrolidone, a maleic or fumaric acid copolymer, a poly(styrenesulfonic acid) (PSS), a polyamido acid, for example a carboxy-terminated polymer of a diamine and a di- or polycarboxylic acid, for example carboxy-terminated Starburst™ PAMAM dendrimers (Aldrich), a poly(2-acrylamido-2-methylpropanesulfonic acid) (poly-(AMPS)), or an alkylene polyphosphate, alkylene polyphosphonate, carbohydrate polyphosphate or carbohydrate polyphosphonate, for example a teichoic acid.

Examples of anionic biopolymers or modified biopolymers are: hyaluronic acid, glycosaminoglycanes such as heparin or chondroitin sulfate, fucoidan, poly-aspartic acid, poly-glutamic acid, carboxymethyl cellulose, carboxymethyl dextranes, alginates, pectins, gellan, carboxyalkyl chitins, carboxymethyl chitosans, sulfated polysaccharides.

A preferred anionic polymer is a linear or branched polyacrylic acid or an acrylic acid copolymer. A more preferred anionic polymer is a linear or branched polyacrylic acid. A branched polyacrylic acid in this context is to be understood as meaning a polyacrylic acid obtainable by polymerizing acrylic acid in the presence of suitable (minor) amounts of a di- or polyvinyl compound.

A suitable cationic polymer is, for example, a synthetic polymer, biopolymer or modified biopolymer comprising primary, secondary or tertiary amino groups or a suitable salt thereof, preferably an ophthalmically acceptable salt thereof, for example a hydrohalogenide such as a hydrochloride thereof, in the backbone or as substituents. Cationic polymers comprising primary or secondary amino groups or a salt thereof are preferred.

### Examples of Synthetic Cationic Polymers are:

(i) a polyallylamine (PAH) homo- or copolymer, optionally comprising modifier units;
(ii) a polyethyleneimine (PEI);
(iii) a polyvinylamine homo- or copolymer, optionally comprising modifier units;
(iv) a poly(vinylbenzyl-tri-C₁-C₄-alkylammonium salt), for example a poly(vinylbenzyl-tri-methyl ammoniumchloride);
(v) a polymer of an aliphatic or araliphatic dihalide and an aliphatic N,N,N′,N′-tetra-C₁-C₄-alkyl-alkylenediamine, for example a polymer of (a) propylene-1,3-dichloride or -dibromide or p-xylylene dichloride or dibromide and (b) N,N,N′,N′-tetramethyl-1,4-tetramethylene diamine;
(vi) a poly(vinylpyridin) or poly(vinylpyridinium salt) homo- or copolymer;
(vii) a poly(N,N-diallyl-N,N-di-C₁-C₄-alkyl-ammoniumhalide) comprising units of formula

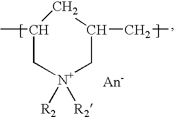

wherein R₂ and R₂′ are each independently C₁-C₄-alkyl, in particular methyl, and An⁻ is a, for example, a halide anion such as the chloride anion;
(viii) a homo- or copolymer of a quaternized di-C₁-C₄-alkyl-aminoethyl acrylate or methacrylate, for example a poly(2-hydroxy-3-methacryloylpropyltri-C₁-C₂-alkylammonium salt) homopolymer such as a a poly(2-hydroxy-3-methacryloylpropyltri-methylammonium chloride), or a quaternized poly(2-dimethylaminoethyl methacrylate or a quaternized poly(vinylpyrrolidone-co-2-dimethylaminoethyl methacrylate);
(ix) POLYQUAD® as disclosed in EP-A456,467; or
(x) a polyaminoamide (PAMAM), for example a linear PAMAM or a PAMAM dendrimer such as a amino-terminated Starbust™ PAMAM dendrimer (Aldrich).

The above mentioned polymers comprise in each case the free amine, a suitable salt thereof, for example a biomedically acceptable salt or in particular an ophthalmically acceptable salt thereof, as well as any quaternized form, if not specified otherwise.

Suitable comonomers optionally incorporated in the polymers according to (i), (iii), (vi) or (viii) above are, for example, acrylamide, methacrylamide, N,N-dimethyl acrylamide, N-vinylpyrrolidone and the like.

Examples of cationic biopolymers or modified biopolymers are: basic peptides, proteins or glucoproteins, for example a poly-ε-lysine, albumin or collagen, aminoalkylated polysaccharides, for example a chitosan, aminodextranes.

A preferred cationic polymer is a polyallylamine homopolymer; a polyallylamine comprising modifier units of the above formula (1); a polyvinylamine homo- or -copolymer or a polyethyleneimine homopolymer, in particular a polyallylamine or polyethyleneimine homopolymer or a poly(vinylamine-co-acrylamid) copolymer.

The molecular weight of the ionic polymers used may vary within wide limits depending on the desired characteristics such coating thickness and the like. In general, a weight average molecular weight of from about 5000 to about 5000000, preferably from 10000 to 1000000, more preferably 15000 to 500000, even more preferably from 20000 to 200000 and in particular from 40000 to 150000, has proven as valuable both for the anionic and cationic polymer.

The non-ionic polymer may be selected from aliphatic hydrocarbons, polyolefins such as low density polyethylene (LDPE), polypropylene (PP), high density polyethylene (HDPE), ultra high molecular weight polyethylene (UHMWPE); polyethers. such as polyoxymethylene (Acetal); polyamides, such as poly(hexamethylene adipamide) (Nylon 66); halogenated polymers, such as polyvinylidenefluoride (PVDF), polytetra-fluoroethylene (PTFE), fluorinated ethylene-propylene copolymer (FEP), and polyvinyl chloride (PVC); hydroxylated polymers such as polyvinylalcohol (PVA), polysaccharides such as cyclodextrins (CD), aromatic polymers, such as polystyrene (PS); ketone polymers such as polyetheretherketone (PEEK); methacrylate polymers, such as polymethylmethacrylate (PMMA); polyesters, such as polyethylene terephthalate (PET); polyurethanes; epoxy resins; and copolymers such as ABS and ethylenepropylenediene (EPDM).

A spacer, whether ionic or non-ionic, may be cross-linked with one or more cross-linkers such as a di- or tri-isocyanate.

Particular spacers include a series of poly(oxyethylene) diamines having a molecular weight up to about 6000 daltons which are commercially available under the tradename Jeffamine® (Texaco Chemical Co., Bellaire, Tex.). The Jeffamine® poly(oxyethylene) diamine resins are aliphatic primary diamines structurally derived from polypropylene oxide-capped polyethylene glycol. These products are characterized by high total and primary amine contents. Other symmetrical diamines having the desired characteristics can be used. For some applications, symmetrical dicarboxylic acid-functionalized polymers having approximately the same general structure can be used.

Other preferred spacers include poly(oxyethylene) diols having a molecular weight up to about 6000 daltons, or poly(oxyethylene-oxypropylene) diols with a molecular weight of up to about 6000 daltons, or PVA with a molecular weight up to 6000 daltons and mixtures thereof.

Typically the spacer is present in an amount in weight percent of about 0.1-40% of the total amount of carrier, preferably from about 0.5 to about 20%, more preferably from about 1 to about 15%, more preferably 5 to about 12% of the total amount of carrier. Preferably each spacer group contains in average up to 4 quaternary ammonium group.

### The Trialkylammonium-Group

The novel polymers of the present invention comprise a trialkylammonium group, wherein three (3) alkyl groups are the same of different from each other, and wherein the substituents in the formula (I) denote:

R₁ is alkyl, preferably lower alkyl;
R₂ is alkyl, preferably lower alkyl; and
R₃ is alkyl, preferably alkyl with up to 25, more preferably up to 20 carbon atoms.

As used herein alkyl is linear or branched and contains up to 30 carbon atoms, more preferably up to 25 carbon atoms, in particular up to 20 carbon atoms, in particular up to 15 carbon atoms. Examples of alkyl are methyl, ethyl, propyl, iso-propyl, butyl, sec-butyl, tert-butyl, pentyl, hexyl, heptyl, octyl, nonyl, decyl, undecyl, dodecyl, and the like. Preferably at least one alkyl contains more carbon atoms than the other alkyl groups and has preferably from 10-20 carbon atoms, preferably from 11-20, preferably from 11-18, preferably from 12-16 carbon atoms.

As used herein, lower alkyl has up to 7 carbon atoms, preferably up to 4, and stands in particular for methyl, ethyl, propyl, iso-propyl, n-butyl, iso-butyl, tert-butyl and sec-butyl, and especially for methyl.

In a preferred aspect, two alkyls represent lower alkyl and one alkyl is alkyl with up to 30 carbon atoms, preferably up to 20 carbon atoms.

Also preferably two alkyl groups are independently from each other methyl, ethyl, propyl or butyl, preferably independently from each other methyl, ethyl or propyl, more preferably independently from each other methyl or ethyl.

Highly preferred are alkyl groups which represent independently of each other methyl, ethyl, propyl, butyl, pentyl, hexyl, heptyl, octyl, nonyl, decyl, undecyl and/or dodecyl, especially two alkyl groups are methyl and one is dodecyl.

In an other preferred aspect the quaternary ammonium group is in accordance to any of the working examples of this invention.

Typically the nitrogen content based upon the total number of quaternary ammonium groups in a polymer is from 0.01-10%, preferably from 0.05-5%, preferably from 0.1-3% of the total weight or a polymer.

Unless specified differently, it is understood that said nitrogen content is based upon the total number of quaternary ammonium groups and is based upon the final article without said carrier, since the amount of a carrier may vary from minute amounts to huge quantities.

### The Residue Y⁻

The residue Y⁻ is typically any conventional inorganic or organic, one or more time, negatively charged moiety, the negatively charged moiety comprising at least of one atom. Such a residue Y⁻ is for example formed by removing at least one proton from an organic or inorganic acid.

Suitable inorganic acids are, for example, halogen acids, such as hydrochloric acid, hydrobromic acid, sulfuric acid, or phosphoric acid.

Suitable organic acids are, for example, carboxylic, phosphonic, sulfonic or sulfamic acids, for example acetic acid, propionic acid, octanoic acid, decanoic acid, dodecanoic acid, glycolic acid, lactic acid, 2-hydroxybutyric acid, gluconic acid, glucosemonocarboxylic acid, fumaric acid, succinic acid, adipic acid, pimelic acid, suberic acid, azelaic acid, malic acid, tartaric acid, citric acid, glucaric acid, galactaric acid, amino acids, such as glutamic acid, aspartic acid, N-methylglycine, acetylaminoacetic acid, N-acetylasparagine or N-acetylcysteine, pyruvic acid, acetoacetic acid, phosphoserine, 2- or 3-glycerophosphoric acid, glucose-6-phosphoric acid, glucose-1-phosphoric acid, fructose-1,6-bis-phosphoric acid, maleic acid, hydroxymaleic acid, methylmaleic acid, cyclohexanecarboxylic acid, adamantanecarboxylic acid, benzoic acid, salicylic acid, 1- or 3-hydroxynaphthyl-2-carboxylic acid, 3,4,5-trimethoxybenzoic acid, 2-phenoxybenzoic acid, 2-acetoxybenzoic acid, 4-aminosalicylic acid, phthalic acid, phenylacetic acid, mandelic acid, cinnamic acid, glucuronic acid, galacturonic acid, methane- or ethane-sulfonic acid, 2-hydroxyethanesulfonic acid, ethane-1,2-disulfonic acid, benzenesulfonic acid, 2-naphthalenesulfonic acid, 1,5-naphthalene-disulfonic acid, 2-, 3- or 4-methylbenzenesulfonic acid, methylsulfuric acid, ethylsulfuric acid, dodecylsulfuric acid, N-cyclohexylsulfamic acid, N-methyl-, N-ethyl- or N-propyl-sulfamic acid, or other organic protonic acids, such as ascorbic acid.

Preferably the negatively charged moiety is derived from an inorganic acid, preferably from hydrochloric acid, hydrobromic acid, sulfuric acid, or phosphoric acid.

### PREFERRED EMBODIMENTS/PRIOR ART LIMITATIONS

U.S. Pat. No. 5,104,649 describes a polyethylene polymer which further contains biologically active quaternary ammonium groups which are grafted to said polymer surface via sulfonamide groups.

In a preferred aspect the articles of the present invention do not contain an —SO₂— or an —SO₂NH— group, which may—inter alia—be represented by any of the groups X₁ and or X₂.

U.S. Pat. No. 5,683,709, which describes the reaction of cross-linked chloromethylated polystyrene with a tertiary amine having dimethyl and a higher alkyl group, e.g. N,N-dimethyldodecylamine, to produce an insoluble polymer containing benzalkonium chloride functionality. The articles of the present invention do not contain quaternary ammonium groups which are more or less directly attached to a polystyrene, said polystyrene representing the carrier, e.g. as describe in U.S. Pat. No. 5,683,709.

However, such prior art polymers might be used together with the articles of the present invention, i.e. use of physical mixtures, granulates and the like, or co-extrusion products, and the like. It has been surprisingly found that mixtures of said known polymers with the articles of this invention typically have an improved efficacy.

### Ways of Manufacturing of Compounds:

The articles of the present invention may be obtainable by various methods and may be manufactured by a method as described in the following paragraphs:

Ethylene oxide or epichlorohydrin may be polymerized directly onto a carrier the surface of which carries proper functional groups, such as hydroxy groups. Such a reaction may be initiated by an initiator, for example by an initiator for a radiation-induced polymerization. Such an initiator is for example a functional photoinitiator having a photoinitiator part and in addition a functional group that is typically co-reactive with functional groups of the substrate, particularly with —OH, —SH, —NH₂, epoxy, carboxanhydride, alkylamino, —COOH or isocyanato groups. The photoinitiator part may belong to different types, for example to the thioxanthone type and preferably to the benzoin type. Suitable functional groups that are co-reactive with the surface of the carrier are for example a carboxy, hydroxy, epoxy or isocyanato group.

Such a polymerization would for example attach polyoxyethylene groups onto the surface of a carrier and the size of said polyoxyethylene group may be controlled by adequate reaction conditions such as solvent, temperature, concentration, pressure, initiator and the like and is known to the skilled man in the art.

The polymerization of epichlorohydrin to the surface of a carrier typically creates an intermediate comprising chloride groups. Such chlorides may be reacted with tertiary amines which would typically produce the quaternary ammonium compounds e.g. as exemplified by formula (I).

Modifications to the reaction sequences, to the substrates and to the reagents as specifically described herein will be easily recognized by the skilled man in the art, therefore said specific reactions and said specific examples shall not be construed in a limiting fashion in any way.

Alternatively, a properly functionalized spacer molecule may be covalently attached to the surface functional group of a carrier by the standard chemical reactions known to the skilled man in the art. Typically, the functional group of the surface should be preferably co-reactive with the functional group comprised in the spacer molecule.

### Further Methods:

Polymerization initiators may be bonded on the surface of the carriers which might be typically those that are initiating a radical polymerization of e.g. an ethylenically unsaturated compound. The radical polymerization may be induced thermally, chemically or also by irradiation.

Suitable thermal polymerization initiators are known to the skilled artisan and comprise for example peroxides, hydroperoxides, azo-bis(alkyl- or cycloalkylnitriles), persulfates, percarbonates or mixtures thereof. Examples are benzoylperoxide, tert.-butyl peroxide, di-tert.-butyl-diperoxyphthalate, tert.-butyl hydroperoxide, azo-bis(isobutyronitrile), 1,1′-azo-bis (1-cyclohexanecarbonitrile), 2,2′-azo-bis(2,4-dimethylvaleronitrile) and the like. The thermal initiators may be linked to the surface of carrier by methods known per se, for example as disclosed in EP-A-0378511.

Initiators for the radiation-induced polymerization are particularly functional photoinitiators having a photoinitiator part and in addition a functional group that is co-reactive with functional groups of the substrate (carrier), particularly with —OH, —SH, —NH₂, epoxy, carboxanhydride, alkylamino, —COOH or isocyanato groups. The photoinitiator part may belong to different types, for example to the thioxanthone type and preferably to the benzoin type. Suitable functional groups that are co-reactive with the surface of the carrier are for example a carboxy, hydroxy, epoxy or isocyanato group.

Various photoinitiators are known to the skilled man in the art and are for example disclosed in U.S. Pat. No. 5,527,925, in PCT application WO 96/20919, or in EP-A-0281941.

### Further Methods Using Co-Reactive Molecules/Polymers

The functionalized carrier may be readily reacted with a di- or tri-isocyanate and with an appropriately functionalized ionic polymer, e.g. carrying hydroxy and/or amino groups, which furnish covalent bonds attaching such an ionic polymer to such a carrier. A carrier being functionalized with hydroxyl groups is for example reacted with a diisocanate and with a polyol such as polyvinylalcohol (PVA) or a polysaccharide or the like, which provides a covalently bound cross-linked polymer coating to said carrier. The remaining functional groups of said coated carrier are then for example converted into groups being coreactive with tertiary amines, the reaction of which would then typically result in the desired final product.

### Surface Functionalization of Carrier:

Suitable surface reactive groups are typically selected from carboxylic, hydroxyl, anhydride, ketone, ester and epoxy groups, which may be introduced through bulk modification and blend with polymer containing these functionalities.

By way of example only, a bulk modification may include but is not limited to bulk grafting or reactive extrusion of polymers with monomers containing unsaturated groups such as glycidyl(meth)acrylate, maleic anhydride, maleic acid, (meth)acrylate ester. Preferable polymers are polyolefins grafted with maleic anhydride or maleic acid and glycidyl(meth)acrylate such as commercial product of polypropylene-graft-maleic anhydride, polyethylene-graft-maleic anhydride, poly(ethylene-co-glycidyl methacrylate). Typical polymer blends include polymer blended with maleated polyolefin, homopolymer or copolymer of glycidyl (meth)acrylate or maleic anhydride such as commercial products of poly(ethylene-alt-maleic) anhydride, poly(isobutyl-alt-maleic anhydride), poly(ethylene-co-vinyl acetate)-graft-maleic anhydride.

### Alternative Carrier Surface Functionalizations:

Many suitable methods are known to modify at least part of a polymer surface to create surface functional groups. The most common treatment is oxidation of the polymer surface but other surface modification methods such as sulfonation with sulfur trioxide gas, or halogenation can for example lead to a surface functionalization suitable for the grafting of polyamino compounds. Surface oxidation techniques which may be used in this invention include for example corona discharge, flame treatment, atmospheric plasma, non-depositing plasma treatment, chemical oxidation, UV irradiation and/or excimer laser treatment in the presence of an oxidising atmosphere such as: air, oxygen (O2), ozone (O3), carbon dioxide (CO2), Helium (He), Argon (Ar), and/or mixtures of these gases. However, for the present technique of an electrical discharge for instance corona discharge or atmospheric plasma, flame treatment, chromic acid treatment, halogenation or combination thereof are preferred.

Suitable corona discharge energies range from 0.1-5000 mJ/mm2 but more preferably 2-800 mJ/mm2. Corona discharge treatment may be carried out in the presence of the following atmospheres: air, oxygen (O2), ozone (O3), carbon dioxide (CO2), Helium (He), Argon (Ar), and/or mixtures of these gases. Suitable treatment times and discharge energies are known to the skilled man in the art and can for example be calculated using the following equations: t=d/v1 (or v2) and E=Pn/lv1 or E=Pn/lv2 t=treatment time for a single pass of treatment under the electrode d=electrode diameter E=discharge energy P=power energy n=number of cycles of treated substrate moving under the electrode l=length of treating electrode v1=speed of treating table v 2=speed of conveyor tape (i.e. continuous treatment) When non-depositing plasma glow discharge treatment is used, the range of suitable energy is 5-5000 Watts for 0.1 seconds to 30 minutes, but more preferably 20-60 Watts for 1 to 60 seconds. Preferable gases are air, oxygen, water or a mixture of these gases.

Alternatively, any known flame treatment may be used to initially oxidize at least part of the surface of the polymer or polymer based material. The range of suitable parameters for the flame treatment are known to the skilled man in the art and may for example be as follows: The oxygen ratio (%) detectable after combustion from 0.05% to 5%, preferably from 0.2% to 2%; treatment speed from 0.1 m/min to 2000 m/min, preferably from 10 m/min to 100 m/min; treatment distance from 1 mm to 500 mm, preferably from 5 mm to 100 mm. Many gases are suitable for flame treatment. These include, but are not limited to: natural gases, pure combustible gases such as methane, ethane, propane, hydrogen, etc or a mixture of different combustible gases. The combustion mixture also includes air, pure oxygen or oxygen containing gases.

Similarly, chemical oxidation of at least part of a polymer surface are known to the skilled man in the art and may for example be effected with any known, standard etching solutions, such as chromic acid, potassium chlorate-sulfuric acid mixtures, chlorate-perchloric acid mixtures, potassium permanganate-sulfuric acid mixtures, nitric acid, sulfuric acid, peroxodisulphate solution in water, chromium trioxide, or a dichromate solution in water, chromium trioxide dissolved in phosphoric acid and aqueous sulphuric acid, etc. More preferably, chromic acid treatment is used. The time taken to complete the treating process can vary between 5 seconds to 3 hours and the process temperature may vary from room temperature to 100° C.

Alternatively, halogenation may for example be used to modify at least part of polymer surface with a halogenating agent to improve for example the interaction of polymer surface with a compound containing an amino group. The halogenation treatment is typically a preferred treatment for a polymer being any natural or synthetic rubber. Suitable halogenating agent may be an inorganic and/or organic halogenating agents in an aqueous or non-aqueous or mixed solvents.

Suitable inorganic halogenating agent include but not limited to fluorine, chlorine, iodine, and bromine as pure gas or any mixture with nitrogen, oxygen, argon, helium or in solutions and acidified hypochlorite solutions. Suitable organic halogenating agents include but not limited to N-halohydantoins, N-haloimides, N-haloamides, N-chlorosulphonamides and related compounds, N,N′-dichlorobenzoylene urea and sodium and potassium dichloroisocyanurate. Specific examples are 1,3-dichloro-5,5-dimethyl hydantoin; 1,3-dibromo-5,5-dimethyl hydantoin; 1,3-dichloro-5-methyl-5-isobutyl hydantoin; 1,3-dichloro-5-methyl-5-hexyl hydantoin, N-bromoacetamide, tetrachloroglycoluril, N-bromosuccincimide, N-chlorosuccinimide, mono-, di-, and tri-chloroisocyanuric acid. Trichloroisocyanuric acid is especially preferred. The halogenation may be carried out at room temperature or at elevated temperature in gas phase or in solution with or without the use of ultrasonication energy. More specified treatment conditions are for example disclosed in U.S. Pat. No. 5,872,190.

### Processing of the Final Articles

The articles according to the invention can be processed in a manner known per se, e.g. by extrusion, by foaming, by injection molding technology or blow fill seal technology, to give moldings, e.g. beads. The invention therefore furthermore relates to moldings which essentially comprise articles according to the invention. Other examples of moldings according to the invention are bottles, dispensing tips, caps, pellets, rods, films, particles, capsules, in particular microcapsules, and plasters.

### Uses:

The articles of the present invention are typically effective against bacteria and viruses, but also against fungi, algae and protozoa. Articles of this invention may represent coatings against such bacteria, fungi, viruses etc., e.g. in bottles comprising pharmaceutical compositions, as protective agents against microbial contamination e.g. in surface coatings, as pellets, beads, films, or particles essentially consisting of articles according to this invention. Also contact lenses may be coated with or manufactured with the articles or macromers of this invention. In an essential aspect an article as described herein is essentially insoluble in an aqueous pharmaceutical composition. The articles of this invention may be combined with known polymers comprising quaternary ammonium groups, e.g. polybenzalkonium chloride, which combination, e.g. physical mixture, co-extrudate, co-polymerization product, typically exhibits a synergistic antimicrobial efficacy.

Accordingly, the present invention provide the use of an article, macromer or copolymer in accordance to the provided disclosure and in accordance to any of the claims in the manufacture of bottles, contact lenses, coatings of any article or of any device, coatings of textiles, pellets, beads, films, or particles of any size, being pharmacologically effective against bacteria and viruses, but also against fungi, algae and protozoa or effective in any process for disinfection.

In another aspect the invention pertains to a method of preserving a pharmaceutical composition comprising contacting said pharmaceutical composition with an article, macromer or copolymer or in accordance to any of the preceding claims, characterized in that said pharmaceutical composition is virtually insoluble in said article, macromer of copolymer.

In a further embodiment this invention describes:

An article comprising a carrier and a macromer attached thereto

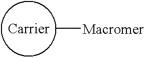

which macromer comprises an optional linking element, a linking group, a spacer and a quaternary ammonium group.

An article wherein said macromer is a compound of formula (I),

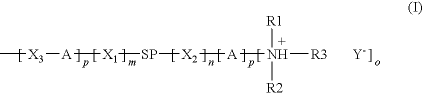

wherein -A- is independent from each other and represents a linking element which linking element has m+1 or o+1 valences, X₁, X₂, and X₃ are the same or different and stand for a linking group, SP is a spacer having n+1 valences, and —N(R₁R₂R₃)⁺ represents a positively charged quaternary ammonium group;
m, n and o are independent from each other and represent an integer from 1-10, preferably 1-7, and more preferably from 1-4, p is 0 or 1, Y⁻ represents a negatively charged inorganic or organic moiety, and the quaternary ammonium group content is from 0.01-25% by weight of nitrogen, preferably from 0.05-12%, also preferably from 0.1-6% of the total weight of said macromer.

An article wherein said macromer is a copolymer which is defined by a co-polymerization product of the following components in weight percent based on the total weight of the polymer:

(1) 45-65% of a macromer according to formula (1) as defined in claim 2,
(2) 15-30% of a hydrophobic monomer, and
(3) 10-35% of a hydrophilic monomer, and
(4) optionally 0.1-10% of a polyunsaturated comonomer.

Article, macromer or copolymer, wherein the quaternary ammonium groups contain three (3) alkyl groups being the same or preferably different from each other, and wherein said alkyl groups consist of the radicals R₁, R₂ and R₃, and wherein

R₁ is alkyl, preferably lower alkyl;
R₂ is alkyl, preferably lower alkyl; and
R₃ is alkyl, preferably alkyl with up to 25 carbon atoms, and more preferably alkyl with up to 20 carbon atoms.

Use of an article, macromer or copolymer in the manufacture of bottles, contact lenses, coatings of any article or of any device, coatings of textiles, pellets, beads, films, or particles of any size, being pharmacologically effective against bacteria and viruses, but also against fungi, algae and protozoa or effective in any process for disinfection.

Method of preserving a pharmaceutical composition comprising contacting said pharmaceutical composition with an article, macromer or copolymer, characterized in that said pharmaceutical composition is virtually insoluble in said article, macromer of copolymer.

Article wherein said carrier comprises polyolefins such as low density polyethylene (LDPE), polypropylene (PP), high density polyethylene (HDPE), ultra high molecular weight polyethylene (UHMWPE); blends of polyolefins with other polymers or rubbers or with inorganic fillers; grafted polyolefins such as a PP or PE which upon funtionalization is grafted with a hydrophilic comonomer such as vinylalcohol and a co-reactant such as a diisocyanate, polyethers such as polyoxymethylene (Acetal); polyamides, such as poly(hexamethylene adipamide) (Nylon 66); halogenated polymers, such as polyvinylidenefluoride (PVDF), polytetra-fluoroethylene (PTFE), fluorinated ethylene-propylene copolymer (FEP), and polyvinyl chloride (PVC); aromatic polymers, such as polystyrene (PS); ketone polymers such as polyetheretherketone (PEEK); methacrylate polymers, such as polymethylmethacrylate (PMMA); polyesters, such as polyethylene terephthalate (PET); polyurethanes; epoxy resins; and copolymers such as ABS and ethylenepropylenediene (EPDM), preferably polyolefins, grafted polyolefins, polyethers, polyamides, polystyrenes, methacrylate polymers and mixtures thereof, more preferably polyethylene, polypropylene, grafted polyethylene, grafted polypropylene, and mixtures thereof.

### Chemistry Section

### Example 1

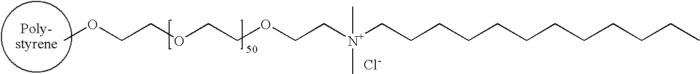

To avoid oxidation of the polymer the reaction is carried out under argon. In a reaction flask with propeller stirrer 49 g TentaGel MB Br (Type MB 300 001; Br-content=0.24 mmol/g) is suspended in 400 ml THF. The resin swells strongly. Then 97 ml (353 mMol) N,N-dodecyldimethylamine is added and the mixture stirred first for 48 hours at 60° C. and then 17 hours at 70° C. After cooling to room temperature the polymer beads are filtered off through a glass filter and washed first with 1 liter THF and then with 1 liter MeOH.

The material is suspended in 200 ml aqueous 0.8 n NaCl solution and gently mixed with a spatula before the solution is drawn through the glass filter. This procedure is repeated 5 times and then again with 5 times with 0.8 n NaCl solution (without MeOH). Finally the material is washed four times with 300 ml water, three times with 300 ml water/MeOH 1:1, four times with 250 ml MeOH, four times with 250 ml THF and four times with 250 ml diethyl ether and dried under reduced pressure (50 mbar) at 50° C. overnight. A yield of 44.5 g polymer beads is obtained. Since the material has a tendency to adhere to glass there is a partial loss on transferring from one vessel to another.

The material produced in this way has a nitrogen content of about 0.4% and a chloride content of 0.65%. The content of bromide ion is <0.1%.

### Example 2

### Prior Art Polymers

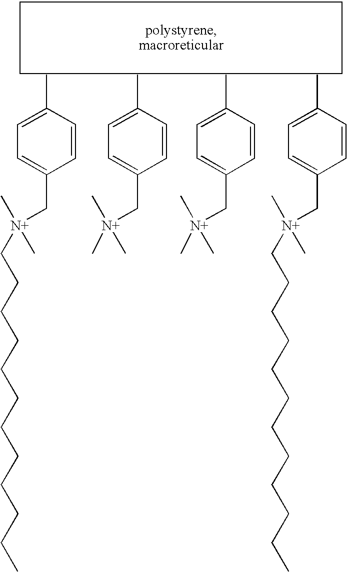

In a 1 l reaction flask with propeller stirrer 90 g Merrifield resin (Aldrich 56, 408-7) with a chloride content of 1.76 mMol/g is suspended in 360 ml THF. Then 16.5 ml (60 mMol) N,N-dimethyldodecylamine und 3.8 ml (16 mMol) of a 33% trimethylamine solution in ethanol is added and the mixture stirred first for 19 hours at 50° C. and then 10 hours at 60° C. Using ¹H-NMR the conversion of N,N-dimethyldodecylamine can be roughly estimated. To this purpose small samples of the liquid phase are removed. Following an addition of further 3.5 ml (12.7 mMol) N,N-dimethyldodecylamine stirring is continued for a further 16 hours at 60° C. After cooling to 50° C. further 81.5 ml (344 mMol) of the 33% trimethylamine solution in ethanol are added and the mixture stirred for 24 hours at this temperature. Thereafter a further 40 ml (170 mMol) of the 33% trimethylamine solution in Ethanol is added and stirred for further 30 hours at 50° C. After cooling to room temperature the polymer beads are filtered off through a glass filter and washed with 500 ml THF. They are then transferred to a Soxhlet apparatus and extracted for 8 hours with THF before being dried on a glass filter, first by air suction and then at 50 mbar during 70 Std. at 50° C. A yield of 101.2 g product (polymer beads) is obtained.

The material produced in this way has a nitrogen content of 1.9% and a chloride content of 4.6%. On the basis of the ¹H-NMR measurements it is estimated that the resin is functionalised with approx ⅓ N,N-dimethyldodecylamine and approx. ⅔ trimethylamine. In water the polymer beads first float on the surface and then sediment completely in less than 4 hours. They swell slightly in ethanol (volume increase about 20%).

### Example 3

### Prior Art Polymers

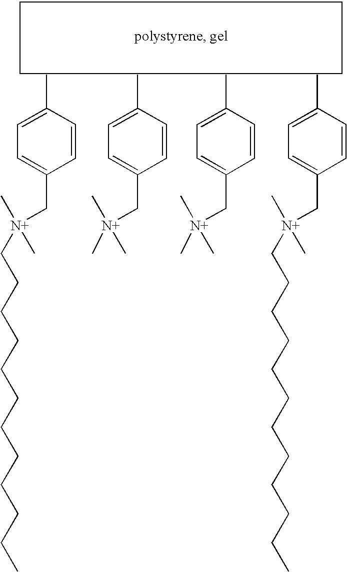

In a 1 l reaction flask with propeller stirrer 60 g Merrifield resin (1% cross-linked, Aldrich 47, 451-7) with a chloride content of 4.73 mMol/g is suspended in 360 ml THF. The resin swells strongly. Then 29.5 ml (107 mMol) N,N-dimethyldodecylamine and 6.6 ml (28 mMol) of a 33% trimethylamine Lösung in ethanol is added and the mixture stirred first for 14 hours at 50° C. and then 2 hours at 60° C. Using ¹H-NMR the conversion of, N-dimethyl-dodecylamine can be roughly estimated. To this purpose small samples of the liquid phase are removed. Following an addition of further 3.5 ml (12.7 mMol) N,N-dimethyldodecylamine stirring is continued for a further 16 hours at 60° C.

After cooling to 50° C. further 90 ml (382 mMol) of the 33% trimethylamine solution in ethanol are added and the mixture stirred for 15 hours at this temperature. Thereafter a further 90 ml (382 mMol) of the 33% trimethylamine solution in ethanol is added and stirred for further 30 hours at 50° C. After cooling to room temperature the polymer beads are filtered off through a glass filter and washed with 500 ml THF and somewhat dried by air suction. The material is transferred to a Soxhlet apparatus and extracted for 8 hours with ethanol. Thereafter it is further washed with THF (5×100 ml) on a glass filter and dried by air suction and then at 50 mbar during 70 Std. at 50° C. A yield of 93.5 g product (polymer beads) is obtained.

The material produced in this way has a nitrogen content of 3.9% and a chloride content of 10.2%. On the basis of the ¹H-NMR measurements it is estimated that the resin is functionalised with approx ⅓ N,N-dimethyldodecylamine and approx. ⅔ trimethylamine. Its swelling properties are markedly different from those of the utilised Merrifield resin: The product practically does not swell in THF, but swells strongly in ethanol and water.

### Example 4

### Prior Art Polymers

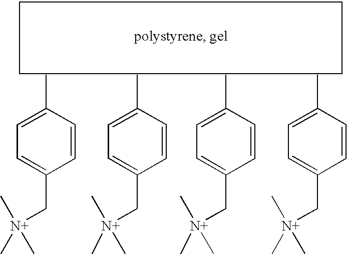

In a 1 l reaction flask with propeller stirrer 60 g Merrifield resin (1% cross-linked, Aldrich 47, 451-7) with a chloride content of 3.52 mMol/g is suspended in 420 ml THF. The resin swells strongly. Then 90 ml (382 mMol) of a 33% trimethylamine Lösung in ethanol is added and the mixture stirred at 50° C. After 30 hours a further 90 ml (382 mMol) of the 33% trimethylamine solution in ethanol is added and the mixture stirred for a further 16 hours at the same temperature. After cooling to room temperature the polymer beads are filtered off through a glass filter and washed with 500 ml THF and somewhat dried by air suction. The material is transferred to a Soxhlet apparatus and extracted for 8 hours with ethanol. Thereafter it is further washed with THF (5×100 ml) on a glass filter and dried by air suction and then at 50 mbar during 70 Std. at 50° C. A yield of 89 g product (polymer beads) is obtained.

The material produced in this way has a nitrogen content of 4% and a chloride content of 9.8%. Its swelling properties are markedly different from those of the utilised Merrifield resin: The product practically does not swell in THF, but swells strongly in ethanol and water.

### Biological Section

### Preparation of the Polymer Beads for Further Microbiological Experiments:

To achieve a decontamination and washing-out of residual source materials of the chemical synthesis, the different types of polymers or the chosen mixture of the different polymers are washed with 70% ethanol, in a suitable manner to get a colourless and odouorless rinsing solution. This is performed using sterile membrane filter units (pore size: 0.2 μm). Any residual solvent is completely removed by suction of the material and storing it for two to three days in a laminar hood using sterile air stream, to avoid a renewed microbiological contamination.

### Microbiological Experiments:

Microbiological experiments are performed to test the antimicrobial activity of the individual polymers or mixtures thereof. For this purpose the classical microorganisms of the pharmacopoeias as e.g. described in chapter 5.1.3. of the European Pharmacopoeia (Ph. Eur), the chapter <51> of the Pharmacopoeia of the United States (USP) and the Japanese Pharmacopoeia (JP) chapter 12 are used for this testing (see next paragraph).

Microorganisms used to assess the antimicrobial activity of the materials:

The microbiological activities are tested with suitable representatives of the following classes of microorganisms:

| | In the further text named as | |
|---|---|---|
| Bacteria: | | |
| Gram | Escherichia coli ATCC 8739 | (E. coli) |
| negative | Pseudomonas aeruginosa ATCC 9027 | (P. aeruginosa) |
| bacteria: | | |
| Gram | Staphylococcus aureus ATCC 6538 | (S. aureus) |
| positive | | |
| bacteria: | | |
| Fungi: | | |
| Filamentous | Aspergillus niger ATCC 16404 | (A. niger) |
| fungi: | | |
| Yeast: | Candida albicans ATCC 10231 | (C. albicans) |

To perform the tests, the concentrations of the microorganisms are taken in accordance with the above-mentioned pharmacopoeial chapters to achieve a final concentration of 10⁵ to 10⁶ CFU/ml (Colony Forming Units per ml) of the organisms in the test system.

All the test materials such as. the nutrients etc. and the incubation conditions were chosen as described in the Pharmacopoeias.

Predefined amounts of dried polymer materials are transferred into sterile test tubes. Sterile aqueous sorbitol solution (5.0% [w:w]) is added to these dried polymer materials until saturation and complete swelling of the material is achieved.

For inoculation with the different individual microorganisms aqueous Sorbitol (5.0% [w:w])-mixtures are prepared in a manner to achieve final concentrations of 10⁵ to 10⁶ CFU/ml. The added volumes are related to the required volumes for microbiological testing. The samples are mechanically mixed.

To determine the corresponding number of surviving microorganisms, aliquots of the inoculated samples of each tested organism are taken out of the test systems.

These tests were performed after the following times of contact of the polymer materials.

Bacteria: (E. coli, P. aeruginosa, S. aureus):
3 hours, 6 hours, 24 hours, 7 days, 14 days, and 28 days
Fungi: (A. niger, C. albicans):
6 hours, 24 hours, 7 days, 14 days, and 28 days

In addition to the contact times required by the European Pharmacopoeia, to assess antimicrobial activity tests were also performed after 3 hours for bacteria and after 6 and 24 hours for the fungi.

Storage during the contact time is under controlled conditions (22.5±2.5° C.).

The taken aliquots are treated (e.g. by dilution) in a manner to get a countable number of microorganisms per Petri dish. The Petri dishes contain suitable nutrient media as required by the pharmacopoeias for the cultivation of the tested microorganisms.

The aliquots of the solvents of the test systems with the inoculated microorganisms are plated out on the Petri dishes with nutrient media. Thereafter they are exposed under controlled conditions to suitable growth temperatures of 30° C. to 35° C. for 24 hours for the bacteria and 20° C. to 25° C. for the fungi. C. albicans is cultured for 48 hours, A. niger for 72 hours.

If, after this incubation period, the surviving organisms are countable, the numbers of colony forming units in the samples are calculated.

In the case that the colonies of the microorganisms are too small to be easily counted the incubation time is extended.

### Results:

The antimicrobial activity of the tested polymers and mixtures of polymers was assessed. There are differences observed between the activity against the bacteria and the fungi in the above tests and between the different tested systems.

### Example 1

### Of Above Text

The antimicrobial activity of the component was sufficient to meet the Ph. Eur. criteria B as well as the antimicrobial efficacy criteria of the USP and the JP.

The activity against bacteria was not adequate to meet the Ph. Eur. A criteria. On the other hand, the reduction of the fungi was suitable to fulfill these A criteria.

### Example 3

### Of Above Text

The antimicrobial activity of the polymer in Example 3 against bacteria was suitable to fulfill the requirements of the Ph. Eur. A criteria. After a contact time of only 3 hours none of the tested bacteria could be determined.

The activity against fungi is much lower. A fungicidal potency against C. albicans and a fungistatic activity against A. niger could be demonstrated. (see Figure MB 2)

The antibacterial activity of the polymer of Example 3 was much higher than that of the polymer of Example 1 whereas the latter was much more active against the fungi (see Figure MB 1 and Figure MB 2).

### MIXTURE of the Polymers of Example 1 and Example 3 (w:w/1:1):

The antimicrobial activity of the mixture of the polymer components of Example 1 and Example 3 (w:w/1:1) was suitable to meet the Ph. Eur. criteria A and B as well as those of the USP and JP. A very good activity against bacteria and fungi could be demonstrated. (see Figure MB 3)

### Results Figure MB 1:

The following results were obtained with the polymer of Example 1 (of above text)

### Challenge Test Results

| | Initial Concentration | CFU/ml or g after a Contact Time of: | | | | | | |
|---|---|---|---|---|---|---|---|---|
| Microorganisms: | (Microorganisms/ml or g) | 3 Hours ( | 6 Hours: | 24 Hours) | 7 Days: | 14 Days: | 21 Days: | 28 Days: |
| Escherichia coli | 7.30E+05 | 40000 | 16000 | 1100 | 0 | 0 | — | 0 |
| ATCC 8739 | | | | | | | | |
| (for USP and JP only) | | | | | | | | |
| Pseudomonas | 3.10E+05 | 2200 | 540 | 0 | 0 | 0 | 0 | 0 |
| aeruginosa | | | | | | | | |
| ATCC 9027 | | | | | | | | |
| Staphylococcus | 3.60E+05 | 32000 | 19000 | 10000 | 0 | 0 | 0 | 0 |
| aureus | | | | | | | | |
| ATCC 6538 | | | | | | | | |
| Candida | 4.00E+05 | — | 35000 | 32000 | 32000 | 2500 | — | 0 |
| albicans | | | | | | | | |
| ATCC 10231 | | | | | | | | |
| Aspergillus | 1.60E+05 | — | 20000 | 8000 | 8000 | 6900 | — | 6400 |
| niger | | | | | | | | |
| ATCC 16404 | | | | | | | | |

Remarks:
0 = <10 (i.e. lower than the limit of determination)

### Results Figure MB 2:

The following results are obtained with the polymer of Example 3 (of above text)

### Challenge Test Results

| | Initial Concentration | CFU/ml or g after a Contact Time of: | | | | | | |
|---|---|---|---|---|---|---|---|---|
| Microorganisms: | (Microorganisms/ml or g) | 3 Hours: | 6 Hours: | 24 Hours) | 7 Days: | 14 Days: | 21 Days: | 28 Days: |
| Pseudomonas | 2.20E+05 | 0 | 0 | 0 | 0 | 0 | 0 | 0 |
| aeruginosa | | | | | | | | |
| ATCC 9027 | | | | | | | | |
| Staphylococcus | 7.60E+05 | 0 | 0 | 0 | 0 | 0 | 0 | 0 |
| aureus | | | | | | | | |
| ATCC 6538 | | | | | | | | |
| Candida | 3.00E+05 | — | 80000 | 22000 | 2600 | 0 | — | 3400 |
| albicans | | | | | | | | |
| ATCC 10231 | | | | | | | | |
| Aspergillus | 4.70E+05 | — | 470000 | 470000 | 470000 | 450000 | — | 450000 |
| niger | | | | | | | | |
| ATCC 16404 | | | | | | | | |

Remarks:
0 = <10 (i.e. lower than the limit of determination)

### Results Figure MB 3:

The following results are obtained with a 1:1 (w:w) mixture of the polymers of Example 1 and Example 3

### Challenge Test Results

| | Initial Concentration | CFU/ml or g after a Contact Time of: | | | | | | |
|---|---|---|---|---|---|---|---|---|
| Microorganisms: | (Microorganisms/ml or g) | 3 Hours | 6 Hours: | 24 Hours) | 7 Days: | 14 Days: | 21 Days: | 28 Days: |
| Escherichia coli | 4.20E+05 | 20000 | 18000 | 3700 | 0 | 0 | — | 0 |
| ATCC 8739 | | | | | | | | |
| (for USP and JP only) | | | | | | | | |
| Pseudomonas | 5.50E+05 | 0 | 0 | 0 | 0 | 0 | — | 0 |
| aeruginosa | | | | | | | | |
| ATCC 9027 | | | | | | | | |
| Staphylococcus | 4.50E+05 | 600 | 200 | 0 | 0 | 0 | — | 0 |
| aureus | | | | | | | | |
| ATCC 6538 | | | | | | | | |
| Candida | 2.80E+05 | — | 17000 | 320 | 0 | 0 | — | 0 |
| albicans | | | | | | | | |
| ATCC 10231 | | | | | | | | |
| Aspergillus | 3.60E+05 | — | 15000 | 15000 | 10000 | 7700 | — | 3100 |
| niger | | | | | | | | |
| ATCC 16404 | | | | | | | | |

Remarks:
0 = <10 (i.e. lower than the limit of determination)

### Meet the Requirements of

| | |
|---|---|
| Ph. Eur. Criteria A | YES |
| Ph. Eur. Criteria B | YES |
| USP | YES |
| JP | YES |

### CONCLUSION

All of the tested polymers exhibit a certain antimicrobial activity.

The antimicrobial behavior of the tested polymers differs with regard to bacteria and fungi.

The polymer of Example 1 is more effective against fungi.

The polymer of Example 3 is more active against bacteria.

The antimicrobial activity of a mixture of both of the polymer types of Example 1 and Example 3 is sufficient to meet the criteria of parenteral and ophthalmic preparations, marketed in multi-dose containers, of the European Pharmacopoeia (fulfills the requirements for criteria A and B), the Pharmacopoeia of the United States and the Japanese Pharmacopoeia.

1. An article comprising a carrier and a macromer attached thereto 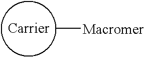
which macromer comprises an optional linking element, a linking group, a spacer and a quaternary ammonium group.

2. An article of claim 1 wherein said macromer is a compound of formula (I), 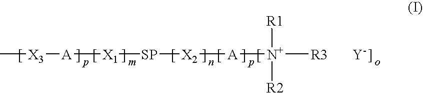
wherein -A- is independent from each other and represents a linking element which linking element has m+1 or o+1 valences, X₁, X₂, and X₃ are the same or different and stand for a linking group, SP is a spacer having n+1 valences, and —N(R1R2R3)+ represents a positively charged quaternary ammonium group;
m, n and o are independent from each other and represent an integer from 1-10, Y represents a negatively charged inorganic or organic moiety, and the quaternary ammonium group content is from 0.01-25% by weight of nitrogen of the total weight of said macromer.

3. An article of claim 2 wherein said macromer is a copolymer which is defined by a copolymerization product of the following components in weight percent based on the total weight of the polymer:
(1) 45-65% of a macromer according to formula (1) as defined in claim 2,
(2) 15-30% of a hydrophobic monomer, and
(3) 10-35% of a hydrophilic monomer, and
(4) optionally 0.1-10% of a polyunsaturated comonomer.

4. An article of claim 1 wherein said quaternary ammonium groups contains three (3) alkyl groups being the same or different from each other, and wherein said alkyl groups consist of the radicals R₁, R₂ and R₃, and wherein
R₁,
R₂ is alkyl, and
R₃ is alkyl.

5. A method of disinfecting bottles, contact lenses, coatings of any article or of any device, coatings of textiles, pellets, beads, films, or particles of any size, against bacteria and viruses, but also against fungi, algae and protozoa comprising the step of applying an article of claim 1 to said bottles, contact lenses, coatings of any article or of any device, coatings of textiles, pellets, beads, films, or particles of any size.

6. Method of preserving a pharmaceutical composition comprising contacting said pharmaceutical composition with an article of claim 1, characterized in that said pharmaceutical composition is virtually insoluble in said article.

7. An article of claim 1 wherein said carrier comprises polyolefins such as low density polyethylene (LDPE), polypropylene (PP), high density polyethylene (HDPE), ultra high molecular weight polyethylene (UHMWPE), blends of polyolefins with other polymers or rubbers or with inorganic fillers, grafted polyolefins such as a PP or PE which upon funtionalization is grafted with a hydrophilic comonomer such as vinylalcohol and a co-reactant such as a diisocyanate, polyethers such as polyoxymethylene (Acetal), polyamides, such as poly(hexamethyl ene adipamide) (Nylon 66), halogenated polymers, such as polyvinylidenefluoride (PVDF), polytetra-fluoroethylene (PTFE), fluorinated ethylene-propylene copolymer (FEP), and polyvinyl chloride (PVC), aromatic polymers, such as polystyrene (PS), ketone polymers such as polyetheretherketone (PEEK), methacrylate polymers, such as polymethylmethacrylate (PMMA), polyesters, such as polyethylene terephthalate (PET), polyurethanes, epoxy resins, and copolymers such as ABS and ethylenepropylenediene (EPDM), preferably polyolefins, grafted polyolefins, polyethers, polyamides, polystyrenes, methacrylate polymers and mixtures thereof, more preferably polyethylene, polypropylene, grafted polyethylene, grafted polypropylene, and mixtures thereof.

8. An article of claim 4, wherein
R1 is lower alkyl,
R2 is lower alkyl, and
R3 is alkyl with up to 25 carbon atoms.
